(19) United States
(12) Patent Application Publication
(10) Pub. No.: US 2015/0012430 A1
(43) Pub. Date: Jan. 8, 2015

(54) SYSTEMS AND METHODS FOR RISK BASED DECISIONING SERVICE INCORPORATING PAYMENT CARD TRANSACTIONS AND APPLICATION EVENTS

(71) Applicant: MasterCard International Incorporated, Purchase, NY (US)

(72) Inventors: John Delton Chisholm, Ballwin, MO (US); Theunis Johannes Gerber, Wildwood, MO (US); Peter J. Groarke, Dublin (IE); Ishfaq A. Lone, Dublin (IE); Mark B. Wiesman, Chesterfield, MO (US)

(21) Appl. No.: 13/934,748

(22) Filed: Jul. 3, 2013

(51) Int. Cl. G06Q 20/40

(52) U.S. Cl. CPC G06Q 20/4016
USPC 705/44

(57) ABSTRACT

A method and system for evaluating a risk of fraud in a payment card transaction using a computer device coupled to a database are provided. The method includes receiving payment card transaction messages relating to a payment card account wherein the payment card transaction messages relate to interactions with a cardholder, an issuer of the payment card account, or an agent thereof. The method further includes receiving payment card account reputation messages that include historical data relating to the trustworthiness of the payment card account, comparing at least one data element in each payment card transaction messages to at least one data element in at least one of: the payment card reputation message and prior transaction history, and determining at least one of a risk of fraud of the transaction and a trustworthiness of the payment card account based on the comparison.

### BACKGROUND OF THE INVENTION

This invention relates generally to risk and fraud associated with payment transaction card accounts, and more particularly, to network-based methods and systems for determining risk and/or fraud associated with a payment card account using transactional and Application Event message data.

At least some known credit/debit card purchases involve the exchange of a number of financial card network messages between the merchant, acquirer, and issuer members of a four party interchange model. Such messages may include authorizations, advices, reversals, account status inquiry presentments, purchase returns and chargebacks.

The credit or debit card payment transaction messages may include several transaction attributes, such as, but, not limited to, primary account number (either real or virtual), transaction amount, merchant identifier, acquirer identifier (the combination of which with above uniquely identifies a merchant), transaction date-time, and address verification.

Fraudulent payment transactions are attempted to be detected and prevented by current systems using a fraud measure or prediction, also known as a “score.” The measure or score is conveyed to one or more of the parties to the transaction that may have liability for the transaction if it turns out to be fraudulent, for example, a merchant, an acquirer, an authorized agent thereof, or an issuer, which enables the party that would be liable to make a more informed decision on whether to proceed with the transaction or not.

Currently, when determining an authorization's fraud prediction score, these systems use, for example, but, not limited to attributes of the authorization, the card's payment history, such as authorization and clearing transaction details and chargebacks, and offline input such as, reports from issuers, merchants, acquirer, cardholders, and law enforcement of compromised PAN or other transaction attributes. Alternatively, a number of authorizations deemed probably fraudulent by the system can result in a PAN or other attribute being marked as “compromised”.

Recently, the Credit/Debit card purchase industry has launched technologies to solve security-related issues and also ease-of-use issues. Examples of these new technologies include Payment Gateway, 3-D Secure, Digital Wallet, Controlled Payment Number, and Online Authentication.

Each of these technologies is associated with messages, which are sometimes referred to as “E-commerce messages” and are used in conjunction with purchases. These e-commerce messages as well as containing a PAN may also contain the following “e-commerce message attributes”: addresses (e.g. billing and shipping), email addresses, phone numbers, and application account id (e.g. wallet id). In addition, because the E-commerce messages are online messages, the IP Address, and fingerprint of the device used may readily be determined if not contained directly in the messages. The E-commerce “Transaction Trust Score” (ETTS) is a function of its' attributes pairing history and in some aspects it's attributes reputation.

Some known real-world systems purport to return a “trust score” on an E-commerce transaction, which is typically based on establishing a track record of usage of the device (as identified by one or more device fingerprints wherein the device can be any mobile device, for example a laptop, a mobile phone, or tablet with other E-commerce attributes, such as, an address or an IP address. The trust score may also include an attribute reputation, for example, but, not limited to a compromised IP address or a compromised email address, which may be obtained from offline input. However, these systems can only return an E-commerce Transaction Trust Score (ETTS) on a particular E-commerce Transaction if queried with a device fingerprint and one or more other message attributes used in the same transaction.

Accordingly, it would be desirable to improve the ability to determine a risk of fraud and trustworthiness of the account information using Application Events rather than relying on device fingerprints in combination with other message attributes.

### BRIEF DESCRIPTION OF THE INVENTION

In one embodiment, a computer-based method for evaluating a risk of fraud in a payment card transaction on a payment card interchange network, is implemented using a computer device coupled to a memory device, and includes receiving payment card transaction messages relating to a payment card account wherein the payment card transaction messages relate to interactions with a cardholder, an issuer of the payment card account, or both. The payment card transaction messages include an authorization request, an authorization response, and an Application Event and the Application Event includes an interaction with the payment card account in other than a purchase interaction wherein the Application Event transaction message further comprising a device identifier comprising at least one of a device identifier and a hardware identifier associated with the device. The method further includes receiving payment card account reputation messages that include historical data relating to the trustworthiness of the payment card account, comparing at least one data element in each payment card transaction messages to at least one data element in at least one of: the payment card reputation message and prior transaction history, and determining at least one of a risk of fraud of the transaction and a trustworthiness of the payment card account based on the comparison.

In another embodiment, a computer system for processing data associated with a payment card cardholder account includes a memory device, a processor in communication with the memory device, and a transaction component configured to receive payment card transaction messages relating to a payment card account, the payment card transaction messages relating to interactions with at least one of an agent on behalf of a cardholder of the payment card account and an agent on behalf of an issuer of the payment card account, the payment card transaction messages including at least one of an authorization request, an authorization response, and an Application Event, the Application Event comprising an interaction with the payment card account in other than a purchase interaction, the Application Event transaction message further comprising a device identifier comprising at least one of a device identifier and a hardware identifier associated with the device. The computer system further includes a reputation component configured to receive payment card account reputation messages that include historical data relating to the trustworthiness of the payment card account, a comparator component configured to compare at least one data element in each payment card transaction messages to at least one data element in at least one of: the payment card reputation message and prior transaction history, and a decisioning component configured to determine at least one of a risk of fraud of the transaction and a trustworthiness of the payment card account based on the comparison.

In yet another embodiment, one or more non-transitory computer-readable storage media has computer-executable instructions embodied thereon, wherein when executed by at least one processor, the computer-executable instructions cause the processor to receive payment card transaction messages relating to a payment card account, the payment card transaction messages relating to interactions with at least one of an agent on behalf of a cardholder of the payment card account and an agent on behalf of an issuer of the payment card account, the payment card transaction messages including at least one of an authorization request, an authorization response, and an Application Event, the Application Event comprising an interaction with the payment card account in other than a purchase interaction, the Application Event transaction message further comprising a device identifier comprising at least one of a device identifier and a hardware identifier associated with the device, receive payment card account reputation messages that include historical data relating to the trustworthiness of the payment card account, compare at least one data element in each payment card transaction messages to at least one data element in at least one of: the payment card reputation message and prior transaction history, determine at least one of a risk of fraud of the transaction and a trustworthiness of the payment card account based on the comparison.

### BRIEF DESCRIPTION OF THE DRAWINGS

FIGS. 1-10 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example system including a plurality of computer devices in accordance with one example embodiment of the present invention.

FIG. 3 is an expanded block diagram of an example embodiment of a server architecture of the system including the plurality of computer devices in accordance with one example embodiment of the present invention.

FIG. 4 illustrates an example configuration of a client system shown in FIGS. 2 and 3.

FIG. 5 illustrates an example configuration of a server system shown in FIGS. 2 and 3.

FIG. 6 is a schematic block diagram of a Risk Based Decisioning Service (RBDS) in accordance with an example embodiment of the present disclosure.

FIG. 7 is a schematic block diagram of a data flow of RBDS shown in FIG. 6.

FIG. 8 is an example of messages associated with e-wallet transactions.

FIG. 9 is an example of messages associated with the purchase transaction.

FIG. 10 is an example of a Payment Gateway notification message.

### DETAILED DESCRIPTION OF THE INVENTION

Embodiments of the methods and systems described herein relate to a Risk Based Decisioning Service (RBDS) that enhances a payment card transaction's fraud prediction score by incorporating non-purchase related messages associated with an account, for example, the messages may be related to account maintenance activities or login to the account online. Examples of Application Event messages may include Payment Gateway order request* and response*, 3-D Secure VEReq, VERes, PAReq*, PARes*, Digital Wallet (sign-in, retrieve address information, and update address information.), Virtual Card Numbers (issue Virtual Card for specified Real Card), other various authentication protocols (authentication request/response). Moreover, the Application Events may occur non-contemporaneously with a purchase transaction and the results of the Application Event may be used to provide trust scores that are requested independent of a purchase transaction. Application Event credential scores enhance Application Event transaction trust scores by incorporating an associated payment card fraud score. Such Application Event transaction trust scores differ from ETTS and include more diverse interactions with the payment card account through account maintenance and account reporting applications. As used herein, Application Event transaction trust scores represent a measure of any of the Application Event Transaction credentials in combination, and not just specifically a device fingerprint combined with the other attributes. Therefore an Application Event transaction trust scores may be measured based solely on, for example an email address and a street address attribute pair for example. Moreover, as used herein, a device identifier may be used to include any scheme that permits a determination of a source device of a message and that may include hardware-based identifiers, software-based identifiers or some other trusted computing identifiers as well as Device Fingerprints.

The methods and systems described herein may be implemented using computer programming or engineering techniques including computer software, firmware, hardware or any combination or subset thereof, wherein the technical effect may include at least one of: (a) receiving payment card transaction messages relating to a payment card account wherein the payment card transaction messages relate to interactions with an agent on behalf of a cardholder of the payment card account or an agent on behalf of an issuer of the payment card account and wherein the payment card transaction messages include an authorization request, an authorization response, and an Application Event, or combinations thereof, (b) Application Event comprising an interaction with the payment card account in other than a purchase interaction, the Application Event transaction message further comprising a device identifier and/or a hardware identifier associated with the device, (c) receiving payment card account reputation messages that include historical data relating to the trustworthiness of the payment card account, (d) comparing at least one data element in each payment card transaction messages to at least one data element in at least one of: the payment card reputation message and prior transaction history, and (e) determining at least one of a risk of fraud of the transaction and a trustworthiness of the payment card account based on the comparison.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

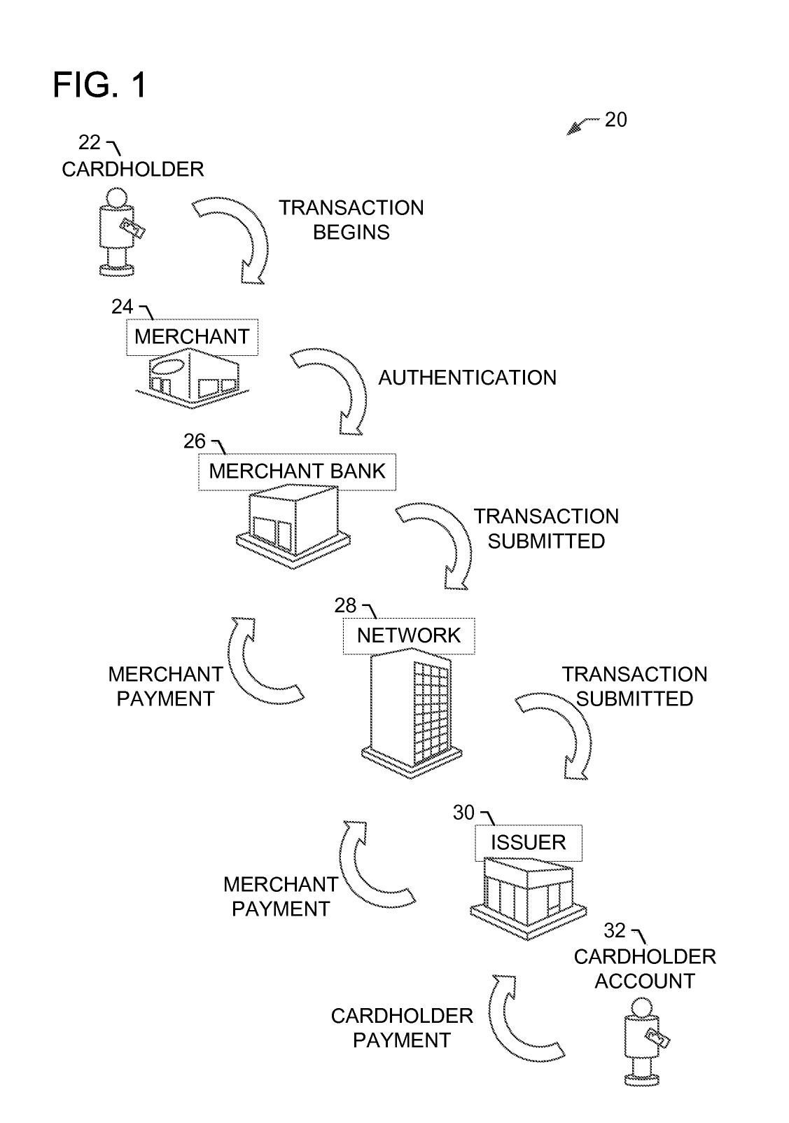

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a four-party payment card interchange network that includes a plurality of special purpose processors and data structures stored in one or more memory devices communicatively coupled to the processors, and a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase, the request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

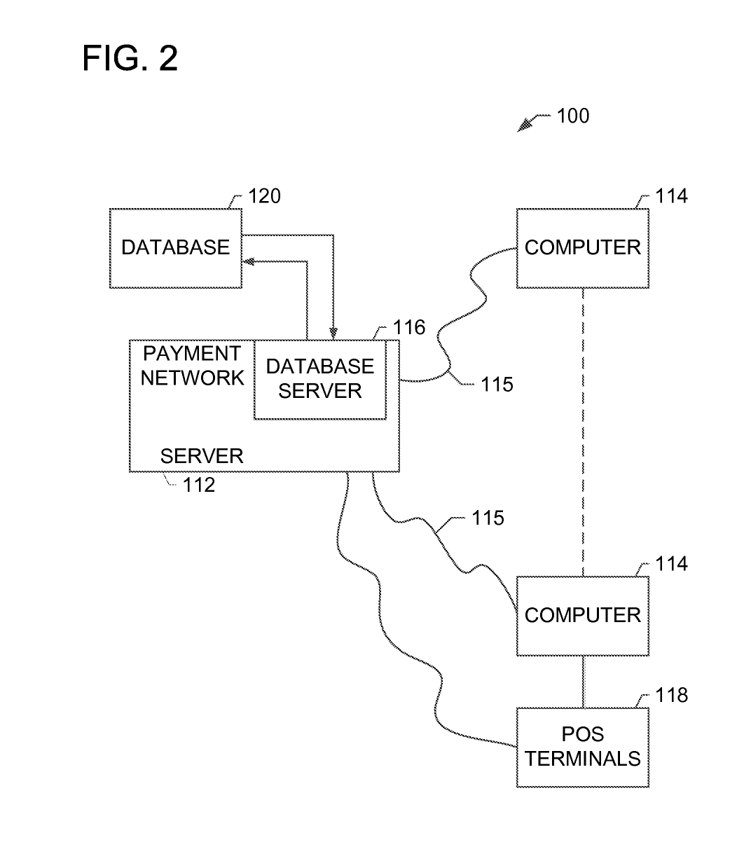

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example processing system 100 including a plurality of computer devices in accordance with one embodiment of the present invention. In the example embodiment, system 100 may be used for performing payment-by-card transactions and/or determining a risk of fraud or payment card account trustworthiness. For example, system 100 may receive payment card transaction information, account event information, and/or offline account trust information from various parties in the four-party interchange or from agencies outside the four-party interchange, determine a score relating to the trustworthiness of the account.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store payment card transaction messages, account event messages, and trust reporting messages, for processing according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, a biller, and/or a risk based decisioning service incorporating payment card transactions and Application Events The risk based decisioning service may be associated with interchange network 28 or with an outside third party in a contractual relationship with interchange network 28. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

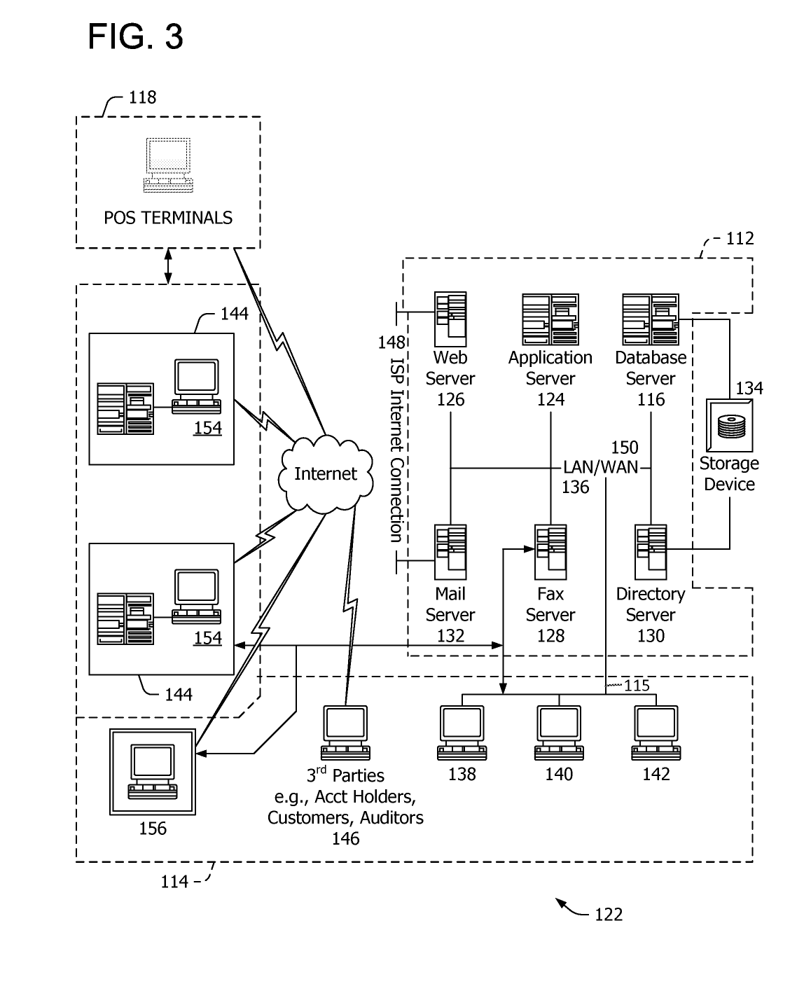

FIG. 3 is an expanded block diagram of an example embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

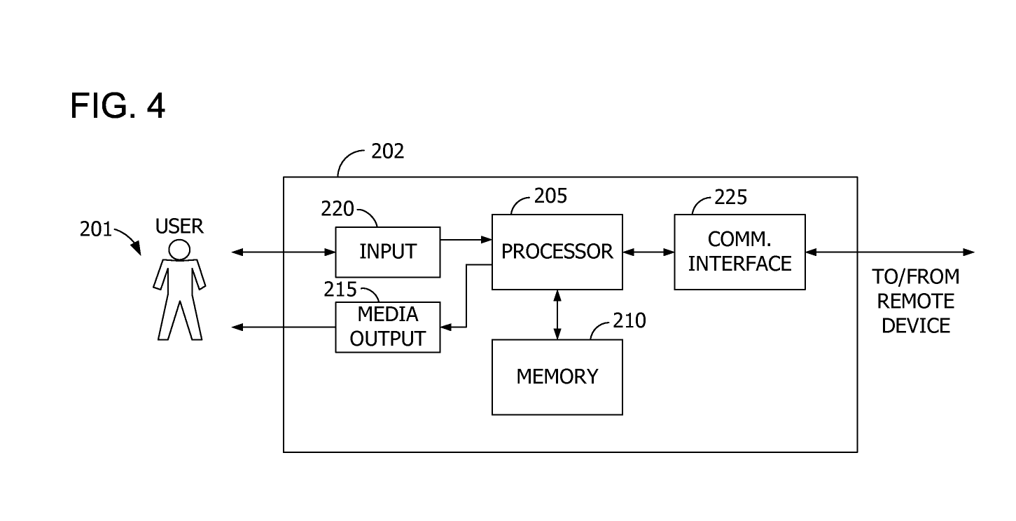

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

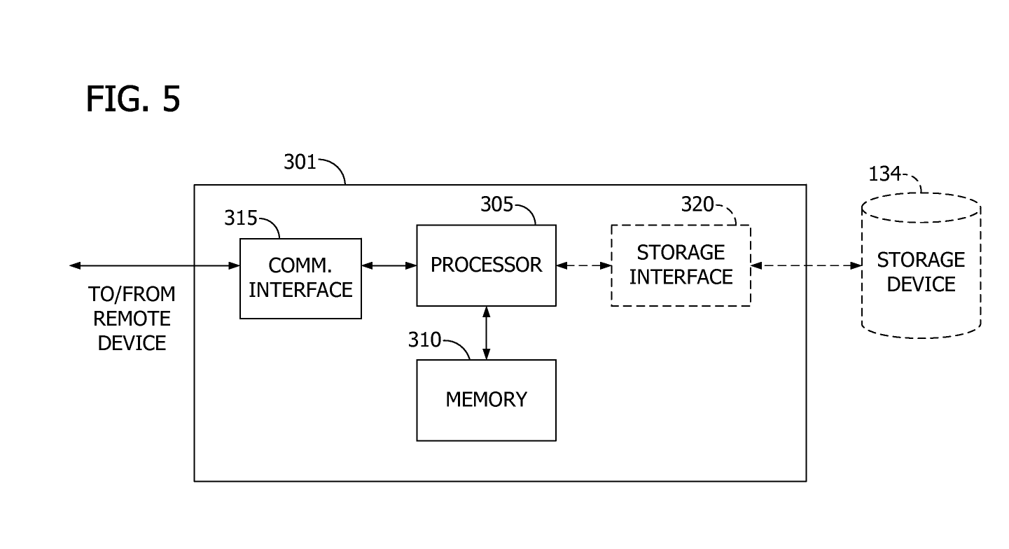

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

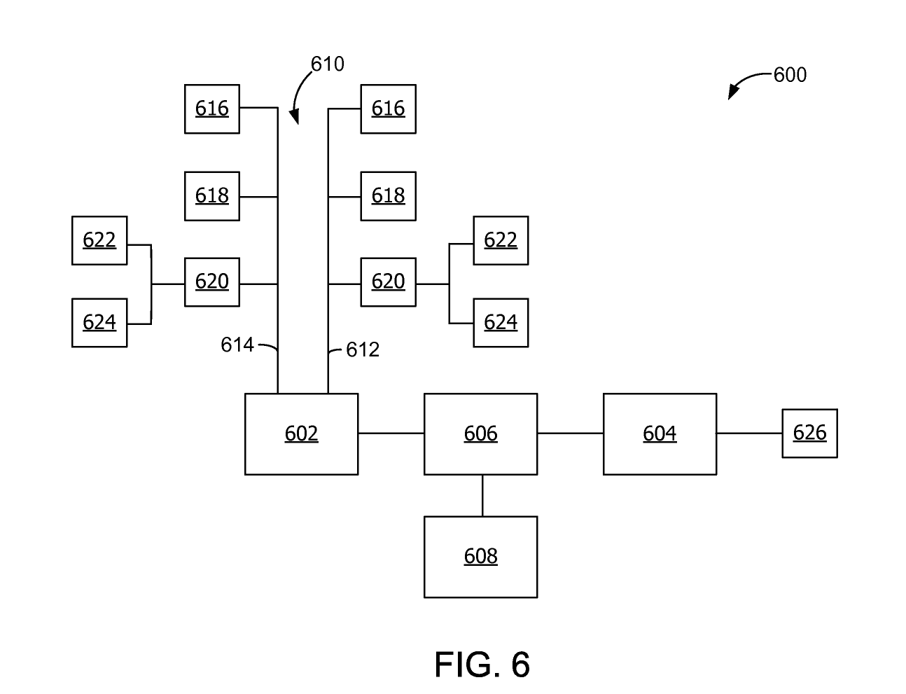

FIG. 6 is a schematic block diagram of a Risk Based Decisioning Service (RBDS) 600 in accordance with an example embodiment of the present disclosure. In the example embodiment RBDS 600 is configured to process data associated with a payment card cardholder account. RBDS 600 includes a memory device and a processor in communication with the memory device. RBDS 600 also includes a transaction component 602 configured to receive transaction messages relating to a payment card account, a reputation component 604 configured to receive payment card account reputation messages, a comparator component 606 configured to compare at least one data element in each transaction message to at least one data element in at least one of: the payment card reputation message and prior transaction history, and a decisioning component 608 configured to determine at least one of a risk of fraud of the transaction and a trustworthiness of the payment card account based on the comparison.

The transaction messages 610 include cardholder messages 612 relating to interactions with a cardholder or an agent on behalf of the cardholder of the payment card account and issuer messages 614 relating to interactions with the issuer or an agent on behalf of an issuer of the payment card account.

In various embodiments, the transaction messages may include an authorization request 616, an authorization response 618, an Application Event 620, or combinations thereof. Application Event 620 represents an interaction with the payment card account in other than a purchase interaction. In some embodiments, the Application Event transaction message may include a device identifier, such as, but, not limited to a device identifier 622 or a hardware identifier 624 associated with the device used in the Application Event.

In the example embodiment, reputation component 604 is configured to receive payment card account reputation messages that may include historical data 626 relating to the trustworthiness of the payment card account. Comparator component 606 is configured to compare data elements in the transaction messages to data elements in the payment card reputation messages or prior transaction history. Decisioning component 608 is configured to determine at least one of a risk of fraud of the transaction and a trustworthiness of the payment card account based on the comparison.

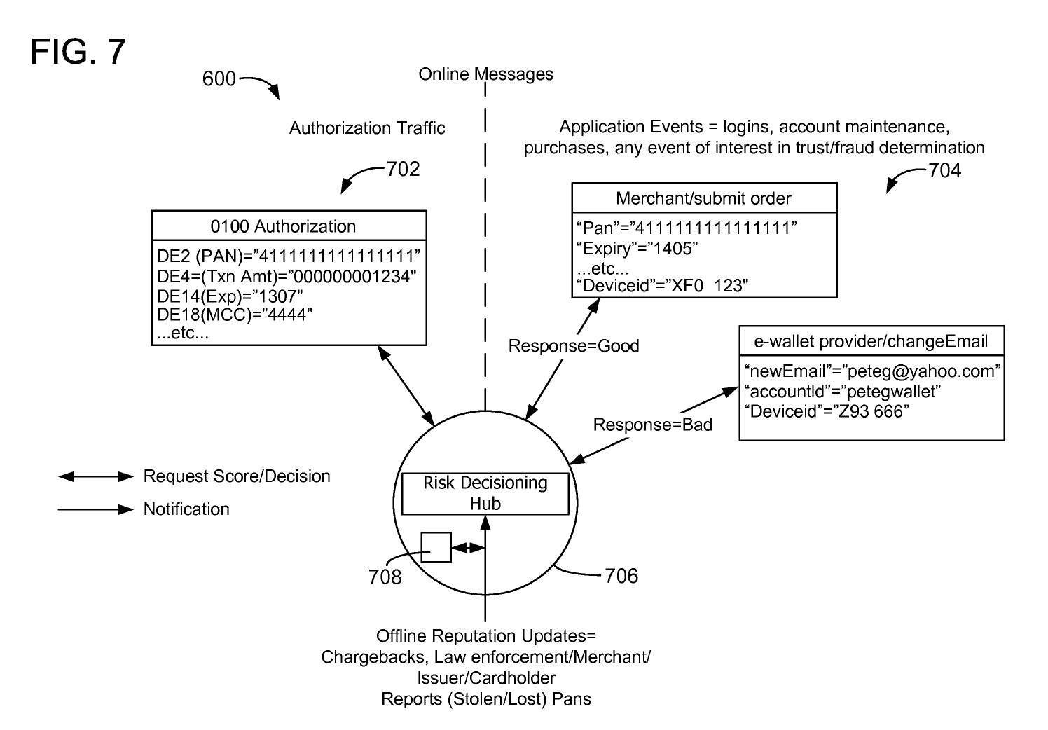

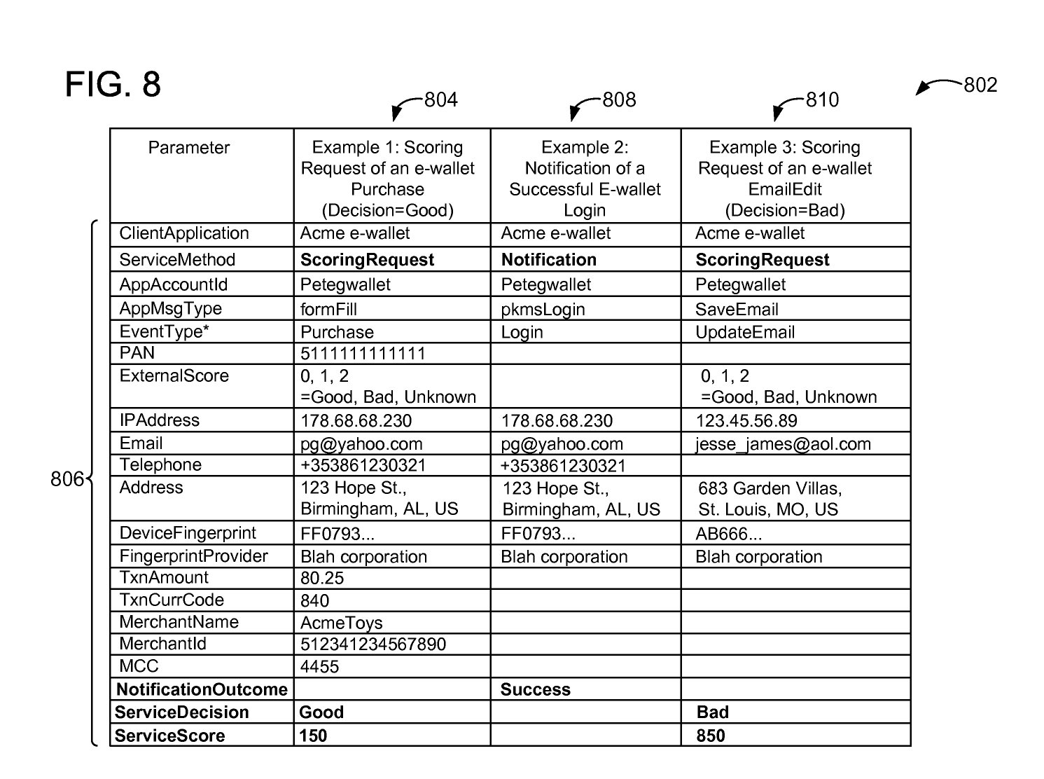

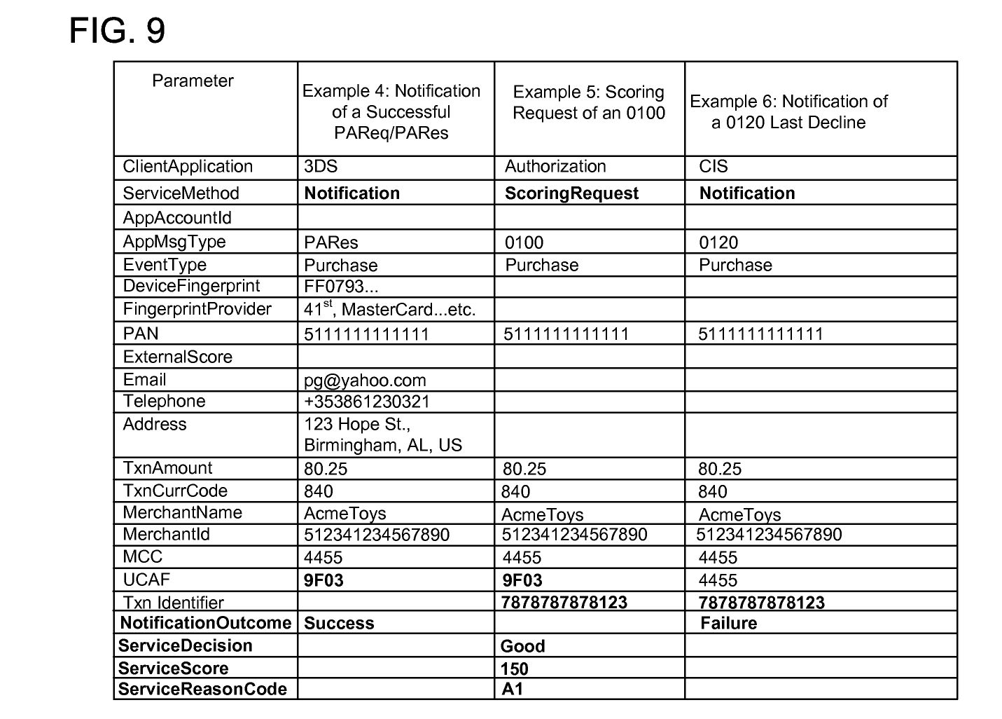

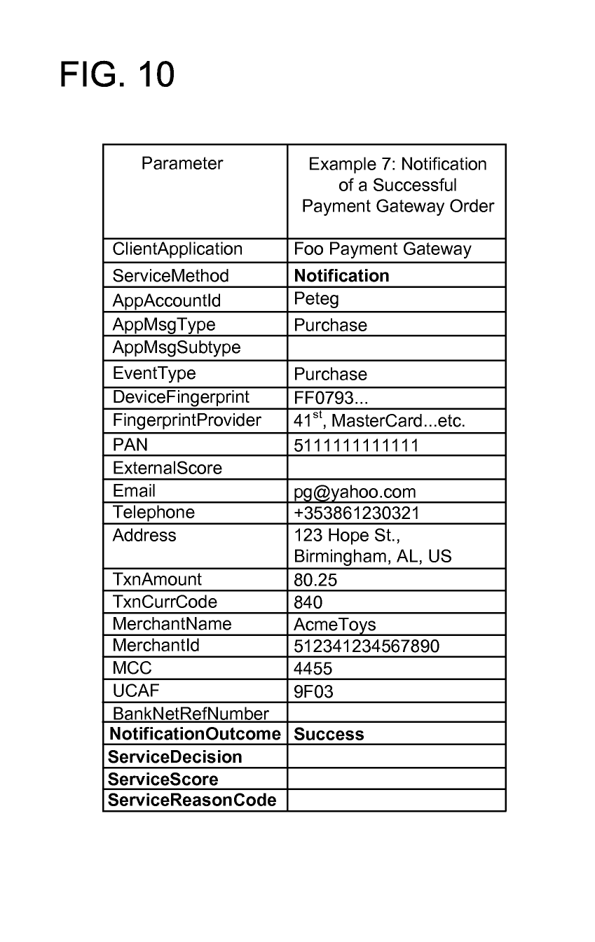

FIG. 7 is a schematic block diagram of a data flow of Risk Based Decisioning Service (RBDS) 600 (shown in FIG. 6). FIG. 8 is an example of messages associated with e-wallet transactions. FIG. 9 is an example of messages associated with the purchase transaction. FIG. 10 is an example of a Payment Gateway notification message.

There are many different types of events in the lifetime of a payment card account that are relevant when determining the likelihood of fraud. One type of event is a payment card transaction 702 and another is an Application Event 704. In a payment card transaction 702, messages and cardholder interactions that relate to the transaction provide information that can be used to facilitate determining fraud during the transaction. Cardholder's may also have other interactions with web sites that can be used to verify they are who they say they are. Application Events 704 may include for example, logins, account maintenance, updating the cardholder's account profile, responding to an email sent to an email address known to be associated with the cardholder, and accessing a website from a device having a known device identifier or hardware identifier.

RBDS 600 includes a hub 706 that incorporates both Payment Card Transactions and also associated Application Events into a risk of fraud and reputation scoring determination. Hub 706 has a comprehensive picture of a given Payment Card's usage pattern and the Payment Card Transaction and Application Events data when analyzed together or independently returns more accurate Card Payment Fraud prediction scores as well as more accurate trust scores. Hub 706 includes a data store 708 that is updated periodically or when requested.

In various embodiments hub 706 provides two different service method/calls, Event Scoring Requests (ESRs) and Event Notifications (ENs). In other embodiments, additional service calls are provided. ENs are notifications to RBDS 600 that a particular event has occurred on a specified client application, whether successful or not. ESRs on the other hand are requests to RBDS 600 to score a particular event.

FIGS. 8-10 illustrate various examples of RBDS messages where authorization messages may be correlated with Application Events for purchase messages and for non-purchase messages. Purchase messages, for example PAReq, PARes, and Payment Gateway Purchase Request/Response may be directly linked to an authorization message (e.g. by a transaction identifier) or indirectly as they contain many of the same fields as an authorization message, such as, PAN, Merchant Id, Amount, Date Time, UCAF, and authorization code. For Non-Purchase Messages, the fields present in an authorization message that may also occur in an Application Event may include, for example, PAN or address. Furthermore, the payment card scheme may include other Application Event attributes, such as, Email, IPAddress, and phone number.

A datastore, for example, a database, or object grid is used to store the Application Events and their attributes: PAN DeviceId, which may include a device identifier or hardware identifier, Email, Address, IP Address, phone numbers and with the associated score. When an Authorization message is received it is matched against any prior Application Event messages in the datastore. If the matched Application Event messages for the Link Attributes used in the Authorization are deemed relatively Risky then this can be taken into consideration when calculating the Authorization Fraud Score. Accordingly, an Authorization's Fraud Score takes into consideration not just the PAN's Card Payment History and Offline Input but also some or all prior linked Application Event Transaction Trust Scores. Conversely, if Card Payment Transactions are stored in a Database then the following process can be used to enhance the Application Event Score, 1) retrieve any Authorization Link field attributes used in an Application Event (PAN, Address), and 2) find prior matching Card Payment Transactions. If one or more of these transactions is deemed as being relatively likely to be fraudulent (e.g. out-of-pattern/risky behavior is detected) or alternatively if a card compromise is reported (e.g. fraud reported on the card) then this is taken into consideration when determining an Application Event Score. Accordingly, each Application Event Score takes into consideration some or all prior Payment Card Transactions and their associated fraud prediction scores.

Results from Application Events, purchase transaction events, and offline reputation updates are used in combination to establish a trust score on a periodic or requested basis. The trust score may be requested from hub 706 or hub 706 may determine a trust score on a periodic basis as information is transmitted to hub 706. As an example, as shown in FIG. 8, three different types of messages 802 relating to e-wallet transactions can be used to determine a trust score. The trust score can either be a current trust score or an indication of a changing trust score may be determined. For example, a cardholder that has established a good trust score may have his card stolen or otherwise compromised. Such compromise may show up as purchases or account queries from a different location than the card history has established. However, if the cardholder goes on vacation or a business trip to that different location, the trust score may also indicate a less trustworthy score, which could lead to a denial of an authorization request during a purchase.

Message1 804 (shown in FIG. 8) is an example of a scoring request of an e-wallet purchase where the decision is determined to be good. Data elements 806 of Message 1 804 include data elements that are used correlate new data received in current messages with data that has already been correlated and/or verified online or offline. Message 2 808 includes data elements 806 that are the same as data elements in message2 808. Such same data elements 806 are compared and the comparison is used to derive a score that indicates a risk of fraud and/or trustworthiness of the cardholder account. For example, data elements AppAccountId, IPAddress, Email, Telephone, Address, DeviceFingerprint, and FingerprintProvider all positively correlate, indicating that the purchase transaction and e-wallet account login were likely conducted by the cardholder. However, data elements 806 of message3 810 do not correlate well with data elements 806 of either message1 804 or message 2 808, which may indicate that the account has been comprised, which may indicate low trust in the transaction (in this embodiment, represented by a large number value of the score).

Data elements 806 of offline reputation updates from for example, but, not limited to chargebacks, compromise reports from law enforcement, merchants, issuers, and/or cardholders may also be correlated to data elements 806 of messages message1, message2, and message3 to determine the risk of fraud or trustworthiness of the associated account.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205 and/or 305, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The above-described embodiments of a method and system for evaluating a risk of fraud in a payment card transaction provides a cost-effective and reliable means for improving a payment card transaction system fraud prediction accuracy by correlating the relevant PAN and/or other link fields with prior Application Event Trust Scores. More specifically, the methods and systems described herein facilitate enhancing the Application Event Trust Score by correlating with associated Payment Card's prior behavior. In addition, the above-described methods and systems facilitate adoption of the system by incentivizing merchants and acquirers to collect and share the maximum of data with processing fee reductions, liability reduction, and/or getting access to the improved fraud prediction system at a preferential rate, which benefits merchants and acquirers as they get a more accurate measure of fraud likelihood thus reducing costly disputes. As a result, the methods and systems described herein facilitate evaluating a risk of fraud in a payment card transaction and a trust score for a cardholder account in a cost-effective and reliable manner. Messages and information are handled in a manner which prevents transactions from being associated with any Personally Identifiable Information (PII). In some cases the attributes and data elements of the transaction can be encrypted such as, by hashing.

Example methods and apparatus for automatically and continuously evaluating a risk of fraud in a payment card transaction are described above in detail. The apparatus illustrated is not limited to the specific embodiments described herein, but rather, components of each may be utilized independently and separately from other components described herein. Each system component can also be used in combination with other system components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-based method for evaluating a risk of fraud associated with a payment card transaction processed over a payment card interchange network, the method implemented using a computer device coupled to a memory device, the method comprising:
receiving, from a first computer system, payment card transaction messages relating to a purchase transaction using a payment card account, the payment card transaction messages relating to interactions between at least one of an agent acting on behalf of a cardholder of the payment card account and an agent acting on behalf of an issuer of the payment card account, the payment card transaction messages including at least one of an authorization request and an authorization response, the payment card transaction messages including an application event, the application event comprising an interaction with the payment card account in other than a purchase interaction and occurring non-contemporaneously with the purchase transaction, the application event transaction message further comprising a device identifier comprising at least one of a software-based device identifier and a hardware identifier associated with the device;
receiving payment card account reputation messages that include historical data relating to the trustworthiness of the payment card account from a second computer system, said second computer system being different than the first computer system;
comparing at least one data element in each payment card transaction messages to at least one data element in at least one of the payment card reputation message and prior transaction history; and
determining at least one of a risk of fraud of the transaction and a trustworthiness of the payment card account based on the comparison.

2. The computer-based method of claim 1, wherein the payment card transaction messages include at least one of a Primary Account Number (PAN), a virtual PAN, a transaction amount, a merchant identifier, an acquirer identifier, a transaction date-time, and an address verification.

3. The computer-based method of claim 1, wherein the payment card reputation messages include at least one of attributes of the authorization, a payment history of the payment card account, historical authorization details, historical clearing transaction details, historical chargeback details, and reports of a compromised PAN.

4. The computer-based method of claim 3, wherein the reports of a compromised PAN are received from at least one of an issuer, a merchant, an acquirer, a payment card cardholder, a law enforcement agency, and security agency.

5. The computer-based method of claim 1, wherein the application event messages include at least one of a billing address, a shipping address, an email address, a phone number, an application account identification (ID), a wallet ID, an Internet protocol (IP) address, a device identifier, and a hardware identifier.

6. The computer-based method of claim 1, wherein personally identifiable information is encrypted to protect the cardholders' privacy.

7. The computer-based method of claim 1, further comprising receiving the payment card transaction messages, the payment card reputation messages, and the application event messages at a central store that is updated periodically.

8. A computer system for processing data associated with a payment card cardholder account, the computer system comprising:
a memory device;
a processor in communication with the memory device;
a transaction component configured to receive payment card transaction messages relating to a purchase transaction using a payment card account from a first computer system, the payment card transaction messages relating to interactions with at least one of an agent acting on behalf of a cardholder of the payment card account and an agent acting on behalf of an issuer of the payment card account, the payment card transaction messages including at least one of an authorization request and an authorization response, the payment card transaction messages including an application event, the application event comprising an interaction with the payment card account in other than a purchase interaction and occurring non-contemporaneously with the purchase transaction, the application event transaction message further comprising a device identifier comprising at least one of a software-based device identifier and a hardware identifier associated with the device;
a reputation component configured to receive payment card account reputation messages that include historical data relating to the trustworthiness of the payment card account from a second computer system, said second computer system being different than the first computer system;
a comparator component configured to compare at least one data element in each payment card transaction messages to at least one data element in at least one of the payment card reputation message and prior transaction history; and
a decisioning component configured to determine at least one of a risk of fraud of the transaction and a trustworthiness of the payment card account based on the comparison.

9. The computer system of claim 8, wherein the payment card transaction messages include at least one of a Primary Account Number (PAN), a virtual PAN, a transaction amount, a merchant identifier, an acquirer identifier, a transaction date-time, and an address verification.

10. The computer system of claim 8, wherein the payment card reputation messages include at least one of attributes of the authorization, a payment history of the payment card account, historical authorization details, historical clearing transaction details, historical chargeback details, and reports of a compromised PAN.

11. The computer system of claim 10, wherein the reports of a compromised PAN are received from at least one of an issuer, a merchant, an acquirer, a payment card cardholder, a law enforcement agency, and security agency.

12. The computer system of claim 8, wherein the application event messages include at least one of a billing address, a shipping address, an email address, a phone number, an application account identification (ID), a wallet ID, an Internet protocol (IP) address, a device identifier, and a hardware identifier.

13. The computer system of claim 8, wherein personally identifiable information is encrypted to protect the cardholders' privacy.

14. The computer system of claim 8, wherein the payment card transaction messages, the payment card reputation messages, and the application event messages are updated periodically at a central store.

15. One or more non-transitory computer-readable storage media having computer-executable instructions embodied thereon, wherein when executed by at least one processor, the computer-executable instructions cause the processor to:
receive, from a first computer system payment card transaction messages relating to a purchase transaction using a payment card account, the payment card transaction messages relating to interactions with at least one of an agent acting on behalf of a cardholder of the payment card account and an agent acting on behalf of an issuer of the payment card account, the payment card transaction messages including at least one of an authorization request and an authorization response, the payment card transaction messages including an application event, the application event comprising an interaction with the payment card account in other than a purchase interaction and occurring non-contemporaneously with the purchase transaction, the application event transaction message further comprising a device identifier comprising at least one of a software-based device identifier and a hardware identifier associated with the device;
receive payment card account reputation messages that include historical data relating to the trustworthiness of the payment card account from a second computer system, said second computer system being different than the first computer system;
compare at least one data element in each payment card transaction messages to at least one data element in at least one of the payment card reputation message and prior transaction history; and
determine at least one of a risk of fraud of the transaction and a trustworthiness of the payment card account based on the comparison.

16. The computer-readable storage media of claim 15, wherein the computer-executable instructions further cause the processor to receive payment card transaction messages that include at least one of a Primary Account Number (PAN), a virtual PAN, a transaction amount, a merchant identifier, an acquirer identifier, a transaction date-time, and an address verification.

17. The computer-readable storage media of claim 15, wherein the computer-executable instructions further cause the processor to receive payment card reputation messages that include at least one of attributes of the authorization, a payment history of the payment card account, historical authorization details, historical clearing transaction details, historical chargeback details, and reports of a compromised PAN.

18. The computer-readable storage media of claim 15, wherein the computer-executable instructions further cause the processor to receive reports of a compromised PAN from at least one of an issuer, a merchant, an acquirer, a payment card cardholder, a law enforcement agency, and security agency.

19. The computer-readable storage media of claim 15, wherein the computer-executable instructions further cause the processor to receive application event messages that include at least one of a billing address, a shipping address, an email address, a phone number, an application account identification (ID), a wallet ID, an Internet protocol (IP) address, a device identifier, and a hardware identifier.

20. The computer-readable storage media of claim 15, wherein the computer-executable instructions further cause the processor to periodically update the payment card transaction messages, the payment card reputation messages, and the application event messages at a central store.
